(19) United States
(12) Patent Application Publication
(10) Pub. No.: US 2023/0333922 A1
(43) Pub. Date: Oct. 19, 2023

(54) Connected Devices Smart Clipboard

(71) Applicant: Motorola Mobility LLC, Chicago, IL (US)

(72) Inventors: Amit Kumar Agrawal, Bangalore (IN); Jing Li, Tongzhou district (CN)

(73) Assignee: Motorola Mobility LLC, Chicago, IL (US)

(21) Appl. No.: 17/730,415

(22) Filed: Apr. 27, 2022

(30) Foreign Application Priority Data
Apr. 19, 2022 (CN) 202210409489.2

(51) Int. Cl. G06F 9/54; H04M 1/72409

(52) U.S. Cl. CPC G06F 9/543; H04M 1/724092

(57) ABSTRACT

In aspects of connected devices smart clipboard, smart clipboard functionality is shared between connected devices, which include at least a mobile wireless device communicatively linked to a computing device, and each of the connected devices implement an instantiation of a smart clipboard. Content may be captured by either of the mobile wireless device or the computing device, and the captured content is shared between the connected devices utilizing the smart clipboard of each respective connected device. A content origin record associated with the captured content is also maintained, where the content origin record includes at least an indication of which of the connected devices captured the content.

### RELATED APPLICATION

This application claims priority benefit of China Patent Application for Invention Serial No. 202210409489.2 filed Apr. 19, 2022 entitled “Connected Devices Smart Clipboard”, the disclosure of which is incorporated by reference herein in its entirety.

### BACKGROUND

Many device users rely on copy and paste functions to copy digital images, copy text, web browser content, and to capture screenshots, to then paste and share, such as for quick social media posts, text messages, and other social media or messaging communications. Posting various web-links, photos, and videos, along with copied or generated text to communicate is a very common use of devices, such as with mobile phones and other wireless communication devices, particularly given current social media platforms, messaging applications, and media content sharing. Typically, devices have a clipboard application or functionality to facilitate these types of quick copy and paste functions. Generally, a clipboard uses a temporary buffered memory that stores the latest copied content, from which a user of a device can then paste into a social media post, text message, or other media application. Further, conventional clipboards are transient in nature, keeping copied content until it is used, or until a next copy function overwrites the previous copied content. Typically, a device clipboard overwrites any previous content as soon as new data (e.g., text, photo, video, etc.) is copied and temporarily made available with the device clipboard.

### BRIEF DESCRIPTION OF THE DRAWINGS

Implementations of the techniques for connected devices smart clipboard are described with reference to the following Figures. The same numbers may be used throughout to reference like features and components shown in the Figures:

FIG. 1 illustrates an example system for connected devices smart clipboard in accordance with one or more implementations as described herein.

FIG. 2 further illustrates examples of connected devices smart clipboard in accordance with one or more implementations as described herein.

FIGS. 3-5 illustrate example methods for connected devices smart clipboard in accordance with one or more implementations of the techniques described herein.

FIG. 6 illustrates various components of an example device that can be used to implement the techniques for connected devices smart clipboard as described herein.

### DETAILED DESCRIPTION

Implementations of techniques for connected devices smart clipboard are implemented as described herein. Connected devices, such as a mobile wireless device (e.g., any type of mobile phone or other wireless device) and a computing device, may be communicatively linked to share smart clipboard functionality between the devices. Each of the connected devices implements an instantiation of a smart clipboard, and content that is captured by either of the mobile wireless device or the computing device can be shared between the connected devices utilizing the smart clipboard of each respective connected device. Generally, captured content may be any type of a digital photo, copied text, a screenshot, an image, a video clip, a hyperlink, or other type of copied content captured with an integrated camera device, a screen copy or screen grab function, or any other type of content copy functionality implemented by the individual connected devices. Each of the connected devices also implement a clipboard content controller that manages the smart clipboard functionality (e.g., the instantiations of the smart clipboard) of the respective mobile wireless device and computing device. The clipboard content controller manages the smart clipboard of a respective connected device to facilitate utilizing and appending contextually relevant content from copied and/or captured content at either of the connected devices, and utilizing the captured content, such as for sharing in a social media post, in a text communication, and/or in any other type of media application.

Generally, a user of the connected devices, such as the mobile wireless device communicatively linked with the computing device, utilizes the quick copy and paste functionality of one of the devices, such as to copy digital images, copy text, web browser content, and to capture screenshots, to then paste and share, such as in a social media post, a text message, or other social media or messaging communication. Posting various web-links, photos, and videos, along with copied or generated text to communicate is a very common use of the devices, such as with mobile phones and other wireless communication devices, particularly given current social media platforms, messaging applications, and media content sharing.

There may be instances when a user needs data from multiple devices, such as text from a copied weblink, video from a computer, and/or other text, a screenshot, or a photo from a phone device, and then combine the various captured content to generate a social media post or message at one of the devices before posting or sending the communication. However, current device clipboard systems do not provide a seamless, easy solution, and typically involves tedious ways of sharing content between devices, such as by manually copying and file sharing from one device to another, and then having to organize and pull the shared content together to create a posting or message. This can be a tedious and untimely process, leading to a poor user experience.

In aspects of the described techniques, the smart clipboard functionality is shared between connected devices, which may be a mobile wireless device communicatively linked to a computing device, and each of the connected devices implement an instantiation of a smart clipboard. Content may be captured by either of the mobile wireless device or the computing device, and the captured content is shared between the connected devices utilizing the smart clipboard of each respective connected device. A content origin record associated with the captured content is also maintained, where the content origin record includes at least an indication of which of the connected devices captured the content.

In implementations, previously captured content is maintained utilizing the smart clipboard of each respective connected device and not overwritten by the captured content. Further, the captured content can be maintained until the content is utilized or consumed, and then the captured content can be cleared from the smart clipboard of each respective connected device responsive to the content being utilized at one of the connected devices. In other aspects of the described techniques, each of the connected devices implements a clipboard content controller that manages the captured content and the respective smart clipboards of the connected devices. The clipboard content controller can determine that a share content scenario has been initiated, and prompt a user to utilize the captured content that is maintained by the smart clipboard of each respective connected device. Further, the clipboard content controller may determine that the captured content is contextually relevant to the share content scenario, and prompt the user to utilize the captured content based on the content being contextually relevant to the share content scenario. In implementations, the clipboard content controller may determine that the captured content is contextually relevant based on a time duration between when the content is captured and when the share content scenario is initiated. Alternatively or in addition, the clipboard content controller may be implemented to utilize natural language processing and/or optical character recognition to determine that the captured content is contextually relevant to the share content scenario.

While features and concepts of the described techniques for a connected devices smart clipboard can be implemented in any number of different devices, systems, environments, and/or configurations, implementations of the techniques for a connected devices smart clipboard are described in the context of the following example devices, systems, and methods.

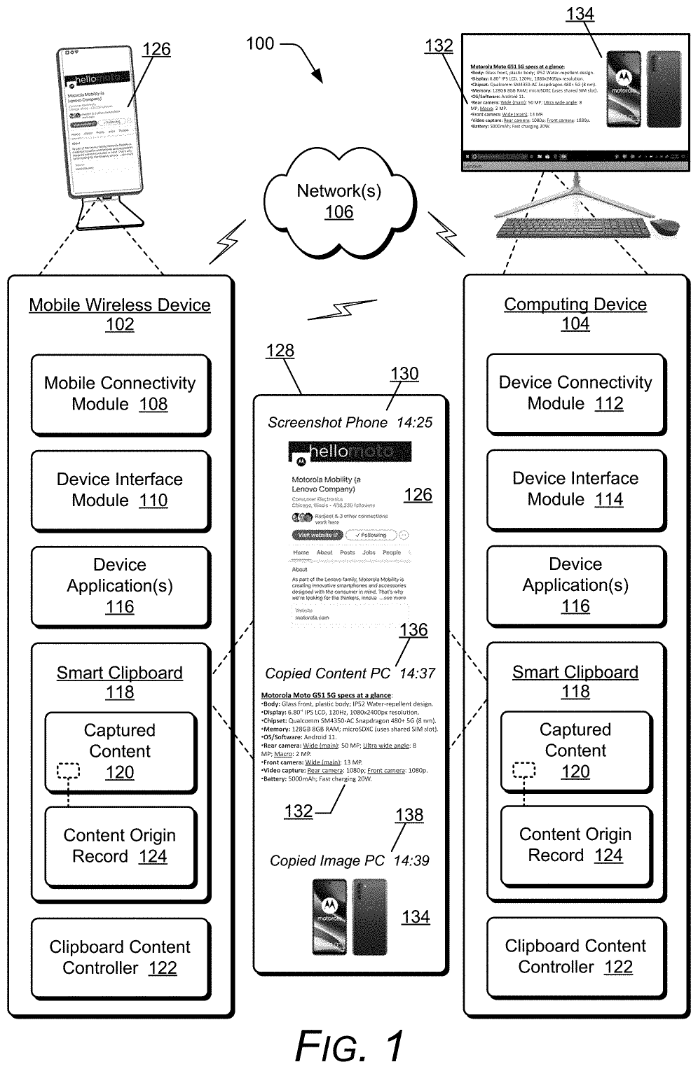

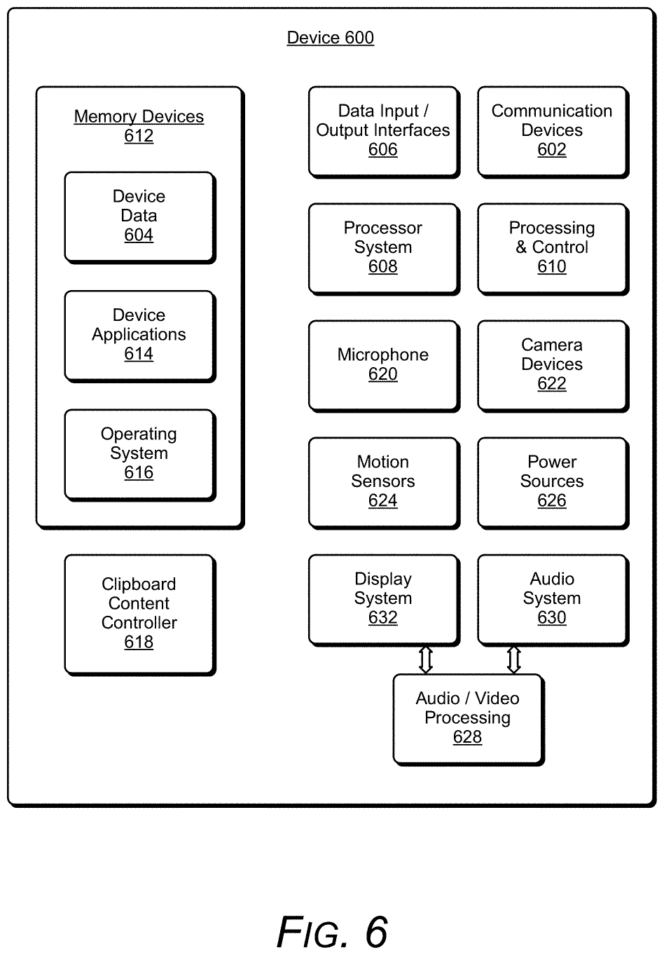

FIG. 1 illustrates an example system 100 for connected devices smart clipboard, as described herein. The system 100 includes a mobile wireless device 102, such as a smartphone, mobile phone, or any other type of wireless device. The mobile wireless device 102 can be implemented with various components, such as a processor system and memory, as well as any number and combination of different components as further described with reference to the example device shown in FIG. 6. In implementations, the mobile wireless device 102 includes various radios for wireless communication with other devices. For example, the mobile wireless device 102 may include a Bluetooth (BT) and/or Bluetooth Low Energy (BLE) transceiver and/or a near field communication (NFC) transceiver. The mobile wireless device 102 may also include a Wi-Fi radio, a GPS radio, and/or any type of device communication interfaces.

The system 100 also includes a computing device 104, such as any type of a computer, a laptop device, a desktop computer, a tablet, a wireless device, a smart device, a media device, a display device, a smart TV, or any other type of a presentation device. Similar to the mobile wireless device 102, the computing device 104 can be implemented with various components, such as a processor system and memory, as well as any number and combination of different components as further described with reference to the example device shown in FIG. 6. In implementations, the mobile wireless device 102 may be communicatively linked, either by a wired or wireless connection, to the computing device 104 on which digital image content can be displayed, such as generated for display by the mobile wireless device 102. The mobile wireless device 102 and the computing device 104 are interconnectable in various ways to enable content from the mobile wireless device to be displayed or otherwise presented by the computing device 104. For example, the mobile wireless device 102 and the computing device 104 are interconnectable via a communication network 106 and/or via direct inter-device connectivity, e.g., via direct wireless and/or wired connectivity between the mobile wireless device 102 and the computing device 104.

Any of the devices, applications, modules, servers, and/or services described herein can communicate via the communication network 106, such as for data communication between the mobile wireless device 102 and the computing device 104. The communication network 106 can be implemented to include a wired and/or a wireless network. The communication network 106 can also be implemented using any type of network topology and/or communication protocol, and can be represented or otherwise implemented as a combination of two or more networks, to include IP-based networks and/or the Internet. The communication network 106 may also include mobile operator networks that are managed by a mobile network operator and/or other network operators, such as a communication service provider, mobile phone provider, and/or Internet service provider.

The mobile wireless device 102 includes various functionality that enables the mobile device to implement different aspects of connected devices smart clipboard, as described herein. In this example, the mobile device 102 includes a mobile connectivity module 108 and a device interface module 110. The mobile connectivity module 108 represents functionality (e.g., logic and/or hardware) enabling the mobile wireless device 102 to interconnect with other devices and/or networks, such as the computing device 104 and the communication network 106. For example, the mobile connectivity module 108 enables wireless and/or wired connectivity of the mobile wireless device 102. The device interface module 110 represents functionality enabling the mobile wireless device 102 to interface with other devices. As further detailed below, the device interface module 110 enables the mobile wireless device 102 to establish wireless and/or wired data communication with other devices, such as the computing device 104 or similar presentation device. The mobile connectivity module 108 and the device interface module 110 can be implemented as computer instructions stored on computer-readable storage media and can be executed by a processor system of the device. Alternatively or in addition, the mobile connectivity module 108 and the device interface module 110 can be implemented at least partially in hardware of the device.

Similarly, the computing device 104 includes various functionality that enables the computing device to implement different aspects of connected devices smart clipboard, as described herein. In this example, the computing device 104 includes a device connectivity module 112 and a device interface module 114. The device connectivity module 112 represents functionality (e.g., logic and/or hardware) enabling the computing device 104 to interconnect with other devices and/or networks, such as the mobile wireless device 102 and the communication network 106. For example, the device connectivity module 112 enables wireless and/or wired connectivity of the computing device 104. The device interface module 114 represents functionality enabling the computing device 104 to interface with other devices. As further detailed below, the device interface module 114 enables the computing device 104 to establish wireless and/or wired data communication with other devices, such as the mobile wireless device 102 or similar devices. The device connectivity module 112 and the device interface module 114 can be implemented as computer instructions stored on computer-readable storage media and can be executed by a processor system of the device. Alternatively or in addition, the device connectivity module 112 and the device interface module 114 can be implemented at least partially in hardware of the device.

A connectivity session can be established between the mobile wireless device 102 and the computing device 104 that enables the mobile wireless device 102 to communicate output content to the computing device 104. In one or more implementations, the connectivity session is established via intercommunication between the device interface module 110 of the mobile wireless device 102 and the device interface module 114 of the computing device 104. The output content may be any type of digital video, images, audio, application interfaces, etc. In one or more implementations, the computing device 104 can output the output content at the device.

The mobile wireless device 102 can communicate any of various types of content to the computing device 104, and vice-versa. In implementations, the mobile wireless device 102 outputs to the computing device 104 content that is being displayed on a display of the mobile wireless device (e.g., also referred to as a mirror mode). In this example, the computing device 104 displays the same content as the mobile wireless device 102, but as a larger size display on the computing device. Alternatively or in addition, the mobile wireless device 102 can output to the computing device 104 content from an application program or operating system without displaying the content on the display of the mobile wireless device. For example, a media application may receive content as a movie from a remote server via the communication network 106 and provide that content to the computing device 104 for display, without displaying or otherwise presenting the content at the mobile wireless device.

The mobile wireless device 102 and/or the computing device 104 can include and implement device applications 116, such as any type of messaging application, email application, video communication application, cellular communication application, music application, gaming application, media application, social platform applications, and/or any other of the many possible types of device applications. Many of the device applications 116 have an associated application user interface that is generated and displayed for user interaction and viewing, such as on a display screen of the mobile wireless device 102 and/or on a display of the computing device 104. Generally, an application user interface, or any other type of video, image, graphic, and the like is digital image content that is displayable on the display screen of the mobile wireless device 102 and/or on the display of the computing device 104.

In this example system 100 for connected devices smart clipboard, the mobile wireless device 102 and the computing device 104 are connected devices that share smart clipboard functionality between the devices. Each of the connected devices implements an instantiation of a smart clipboard 118 (e.g., as a device application 116). Content 120 that is captured by either of the mobile wireless device 102 or the computing device 104 can be shared between the connected devices utilizing the smart clipboard 118 of each respective connected device. Generally, captured content 120 may be any type of a digital photo, copied text, a screenshot, an image, a video clip, a hyperlink, or other type of copied content captured with an integrated camera device, a screen copy or screen grab function, or any other type of content copy functionality implemented by the mobile wireless device 102 and/or the computing device 104. Each of the connected devices also implement a clipboard content controller 122 that manages the smart clipboard functionality (e.g., the instantiations of the smart clipboard 118) of the respective mobile wireless device and computing device.

In implementations, the mobile wireless device 102 and the computing device 104 implement the smart clipboard 118 and the clipboard content controller 122, each of which may include independent processing, memory, and/or logic components functioning as a computing and/or electronic device integrated with the mobile wireless device and/or computing device. Alternatively or in addition, either of the smart clipboard 118 and the clipboard content controller 122 can be implemented in software, in hardware, or as a combination of software and hardware components. In this example, the smart clipboard 118 and the clipboard content controller 122 are implemented as software applications or modules, such as executable software instructions (e.g., computer-executable instructions) that are executable with a processor system of the mobile wireless device 102 or computing device 104 to implement the techniques and features described herein.

As a software application or module, the smart clipboard 118 and/or the clipboard content controller 122 can be stored on computer-readable storage memory (e.g., memory of a device), or in any other suitable memory device or electronic data storage implemented with the module. Alternatively or in addition, either of the smart clipboard 118 and the clipboard content controller 122 may be implemented in firmware and/or at least partially in computer hardware. For example, at least part of the modules may be executable by a computer processor, and/or at least part of the modules may be implemented in logic circuitry. As a device application implemented by the mobile wireless device 102 and the computing device 104, the smart clipboard 118 and/or the clipboard content controller 122 may have an associated application user interface that is generated and displayable for user interaction and viewing, such as on a display screen of the mobile wireless device 102 and the computing device 104. Generally, an application user interface, or any other type of video, image, graphic, and the like is digital image content that is displayable on the display screen of the mobile wireless device 102 and/or on a display screen of the computing device 104.

In implementations, the captured content 120 is maintained utilizing the smart clipboard 118 of each respective connected device (e.g., the mobile wireless device 102 and the computing device 104). Additionally, a content origin record 124 associated with respective captured content 120 is maintained by the clipboard content controller 122 of each device. A content origin record 124 can include at least an indication of which of the connected devices captured the content and/or a date/timestamp to indicate when the content was captured by a device. For example, a user of the mobile wireless device 102 may initiate to capture a screenshot 126 of a social media page, as represented being displayed on the display screen of the mobile wireless device. The screenshot 126 is then captured content 120 that is shared between the connected devices (e.g., from the mobile wireless device 102 to the computing device 104). An example 128 represents the smart clipboard 118 of both connected devices, and the screenshot 126 captured with the mobile wireless device 102 is maintained by the respective instantiations of the smart clipboard 118 for each device. Notably, the screenshot 126 is instantly available for use on either of the devices. Additionally, the clipboard content controller 122 maintains a content origin record 130 associated with the captured screenshot 126 on the respective instantiations of the smart clipboard 118 for each device. In this example, the content origin record 130 indicates that the screenshot 126 was captured on the mobile wireless device 102 (e.g., phone) at a particular time.

In a similar example, a user of the computing device 104 may initiate to capture text content 132 displayed on the display screen of the computing device. The user may also capture a digital image 134 displayed on the display screen of the computing device. The text content 132 and the digital image 134 are then captured content 120 that is shared between the connected devices (e.g., from the computing device 104 to the mobile wireless device 102). The example 128 representing the smart clipboard 118 of both connected devices includes the text content 132 and the digital image 134 captured with the computing device 104, and the captured content is maintained by the respective instantiations of the smart clipboard 118 for each device. Additionally, the clipboard content controller 122 maintains a content origin record 136 associated with the captured text content 132 on the respective instantiations of the smart clipboard 118 for each device. In this example, the content origin record 136 indicates that the text content 132 was captured on the computing device 104 (e.g., PC) at a particular time. Similarly, the clipboard content controller 122 maintains a content origin record 138 associated with the captured digital image 134 on the respective instantiations of the smart clipboard 118 for each device. In this example, the content origin record 138 indicates that the digital image 134 was captured on the computing device 104 (e.g., PC) at a particular time.

Notably, the clipboard content controller 122 maintains previously captured content utilizing the smart clipboard 118 of each respective connected device and does not overwrite the previously captured content with subsequent captured content. For example, the example 128 representing the smart clipboard 118 of both connected devices includes the screenshot 126 captured with the mobile wireless device 102. Rather than overwriting the screenshot 126 when the text content 132 is captured at the computing device 104, the clipboard content controller 122 maintains the previously captured screenshot 126 utilizing the smart clipboard 118 of each respective connected device and does not overwrite the captured screenshot 126 with the subsequent captured text content 132. Similarly, when the digital image 134 is captured at the computing device 104, the clipboard content controller 122 maintains the previously captured text content 132 and does not overwrite the captured digital image 134 with the subsequent captured digital image 134.

Overall, the clipboard content controller 122 is implemented to maintain the captured content 120 utilizing the smart clipboard 118 at each respective connected device until the captured content is utilized or shared (also referred to as consumed). For example, a user of the devices may initiate to paste any combination of the several different captured content 120 into a message or into a social media communication shared with others, in which case the utilized, consumed, or shared captured content can be cleared from the smart clipboard 118 of each connected device. Notably, the clipboard content controller 122 for each connected device can clear the captured content 120 from the smart clipboard 118 of each respective connected device responsive to the captured content being utilized at one of the connected devices.

Generally, many device users, such as a user of the connected devices (e.g., the mobile wireless device 102 and the computing device 104) utilize the quick copy and paste functionality of the devices, such as to copy digital images, copy text, web browser content, and to capture screenshots, to then paste and share, such as for social media posts, text messages, and other social media or messaging communications. Posting various web-links, photos, and videos, along with copied or generated text to communicate is a very common use of the devices, such as with mobile phones and other wireless communication devices, particularly given current social media platforms, messaging applications, and media content sharing.

In implementations of connected devices smart clipboard, the clipboard content controller 122 implemented by the mobile wireless device 102 and/or by the computing device 104 can determine when a share content scenario has been initiated, such as by a user of the one of the connected devices. For example, a user of the mobile wireless device 102 may access a social media site or open a messaging application on the device. Given that the user may likely want to communicate recently captured content 120 via a social media post or in a text message, for example, the clipboard content controller 122 can determine the likely share content scenario and prompt the user to utilize the captured content 120 that is maintained by the smart clipboard 118 of the connected device. In this example, the clipboard content controller 122 may determine that captured content 120 was recently captured and prompt the user to utilize the captured content in a likely share content scenario based on the date/timestamp of the content origin record 124 associated with the captured content. In implementations, the clipboard content controller 122 can detect or receive any one or more indications (e.g., from the operating system) that a social media site has been accessed, that a messaging interface has been opened and is in use, that a messaging application has been accessed, that a message draft is being created, and the like, and then initiate to prompt the user, such as with a user interface displayed prompt, to utilize the captured content 120 that is maintained on the smart clipboard 118 of the device.

In further aspects of connected devices smart clipboard, the clipboard content controller 122 implemented by the mobile wireless device 102 and/or by the computing device 104 can determine when a share content scenario has been initiated, and then determine whether the captured content is contextually relevant to the share content scenario. In implementations, the clipboard content controller 122 may utilize natural language processing and/or optical character recognition to determine that the captured content 120 on the smart clipboard 118 is contextually relevant to the share content scenario. For example, natural language processing may be used to extract keywords from the captured text content 132, and optical character recognition (or another type of computer vision functionality) can be used to identify words and/or objects in the captured digital image 134. From the extracted keywords, identified words, and/or identified objects, the clipboard content controller 122 can then determine whether the captured content items are related and/or whether they may be contextually relevant to a social media post that is being drafted, a text message draft that is being created, and the like. Further, the clipboard content controller 122 can prompt to utilize the captured content 120 responsive to a determination that the captured content is contextually relevant to a share content scenario. In another aspect, the clipboard content controller 122 may also utilize an associated content origin record 124 to determine that captured content 120 is contextually relevant based on a time duration between the content being captured and the share content scenario being initiated.

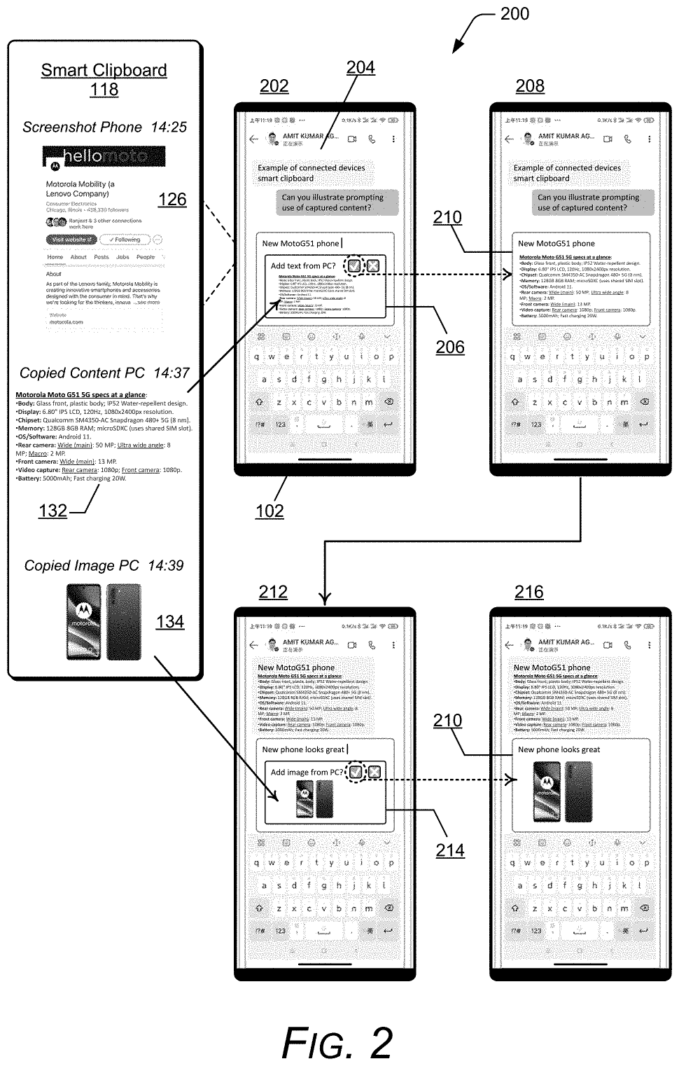

FIG. 2 further illustrates examples 200 of connected devices smart clipboard, as described herein. In these examples, a first instance 202 of the mobile wireless device 102 displays a messaging user interface 204 (e.g., a text messaging application user interface) on the display screen of the device. As the user inputs a message in the text entry field in the user interface, the clipboard content controller 122 implemented by the mobile wireless device 102 detects or receives an indication that the text messaging application has been accessed and that a message draft is being created. The clipboard content controller 122 can then initiate to prompt the user, such as with a user interface displayed prompt 206, to utilize the captured content 120 (e.g., the captured text content 132) that is maintained on the smart clipboard 118 of the device. As shown in the second instance 208 of the mobile wireless device 102, the messaging user interface indicates that the user of the device has initiated or accepted to include the captured content 120 in the text entry field 210 for the message that is being created.

Similarly, a third instance 212 of the mobile wireless device 102 displays the messaging user interface 204 (e.g., a text messaging application user interface) on the display screen of the device. As the user inputs another message in the text entry field in the user interface, the clipboard content controller 122 implemented by the mobile wireless device 102 detects or receives an indication that the message draft is being created. The clipboard content controller 122 can then initiate to prompt the user, such as with a user interface displayed prompt 214, to utilize the captured content 120 (e.g., the captured digital image 134) that is maintained on the smart clipboard 118 of the device. As shown in the fourth instance 216 of the mobile wireless device 102, the messaging user interface indicates that the user of the device has initiated or accepted to include the captured digital image 134 in the text entry field 210 for the message that is being created. Additionally, the clipboard content controller 122 can determine that the share content scenario has been initiated (e.g., the text messaging application is being used on the device), and determine that the captured content is contextually relevant to the share content scenario. In this example, the message text entered by the user in the text entry field in the application user interface is identifiable and contextually relevant to the captured text content 132 and to the captured digital image 134.

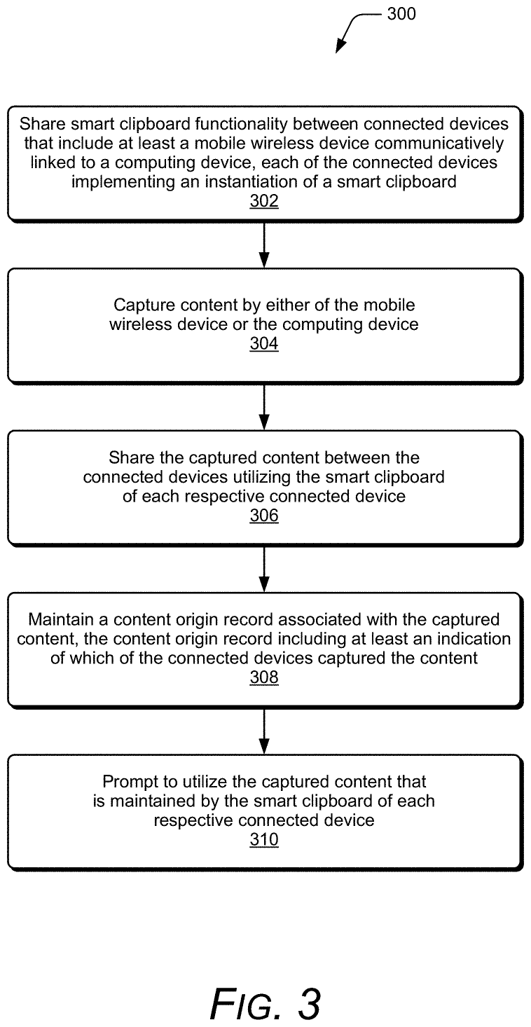

Example methods 300, 400, and 500 are described with reference to respective FIGS. 3, 4, and 5 in accordance with implementations for connected devices smart clipboard. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for connected devices smart clipboard. The order in which the method is described is not intended to be construed as a limitation, and any number or combination of the described method operations can be performed in any order to perform a method, or an alternate method.

At 302, smart clipboard functionality is shared between connected devices that include at least a mobile wireless device communicatively linked to a computing device, each of the connected devices implementing an instantiation of a smart clipboard. For example, the mobile wireless device 102 and the computing device 104 are connected devices that share smart clipboard functionality between the devices, and each of the connected devices implements an instantiation of the smart clipboard 118. Each of the connected devices also implement the clipboard content controller 122 that manages the smart clipboard functionality (e.g., the instantiations of the smart clipboard 118) of the respective mobile wireless device and computing device.

At 304, content is captured by either of the mobile wireless device or the computing device. For example, the mobile wireless device 102 and/or the computing device 104 captures content, which may be any type of a digital photo, copied text, a screenshot, an image, a video clip, a hyperlink, or any other type of copied content captured with an integrated camera device, a screen copy or screen grab function, or any other type of content copy functionality implemented by the mobile wireless device 102 and/or the computing device 104.

At 306, the captured content is shared between the connected devices utilizing the smart clipboard of each respective connected device. For example, the content 120 that is captured by either of the mobile wireless device 102 or the computing device 104 is shared between the connected devices utilizing the smart clipboard 118 of each respective connected device.

At 308, a content origin record associated with the captured content is maintained, the content origin record including at least an indication of which of the connected devices captured the content. For example, the content origin record 124 associated with respective captured content 120 is maintained by the clipboard content controller 122 of each device. A content origin record 124 can include at least an indication of which of the connected devices captured the content and/or a date/timestamp to indicate when the content was captured by a device.

At 310, a prompt is initiated to utilize the captured content that is maintained by the smart clipboard of each respective connected device. For example, the clipboard content controller 122 prompts a user of a connected device to utilize the captured content 120 that is maintained by the smart clipboard 118 of the connected device, given that the user may likely want to communicate recently captured content 120 via a social media post or in a text message.

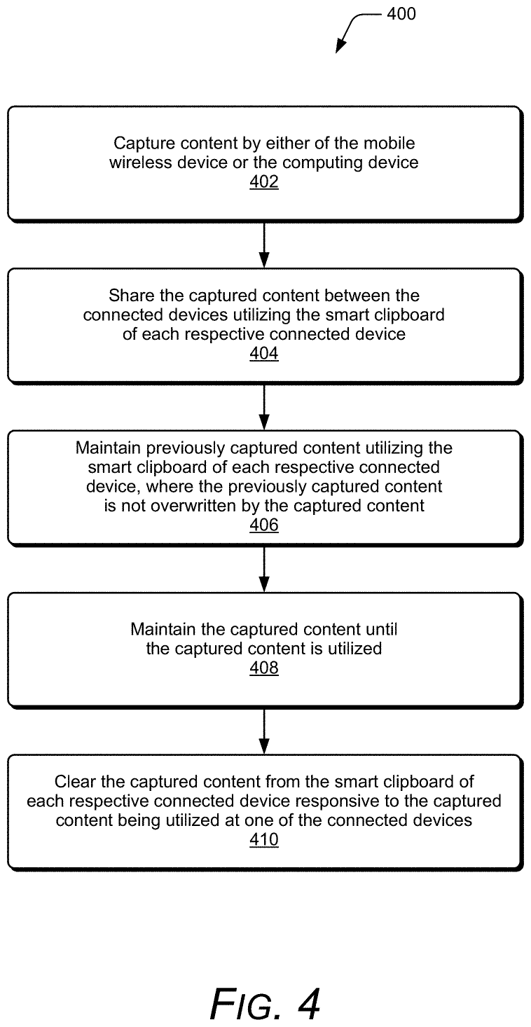

FIG. 4 illustrates example method(s) 400 for connected devices smart clipboard. The order in which the method is described is not intended to be construed as a limitation, and any number or combination of the described method operations can be performed in any order to perform a method, or an alternate method.

At 402, content is captured by either of the mobile wireless device or the computing device. For example, the mobile wireless device 102 and/or the computing device 104 captures content, which may be any type of a digital photo, copied text, a screenshot, an image, a video clip, a hyperlink, or any other type of copied content captured with an integrated camera device, a screen copy or screen grab function, or any other type of content copy functionality implemented by the mobile wireless device 102 and/or the computing device 104.

At 404, the captured content is shared between the connected devices utilizing the smart clipboard of each respective connected device. For example, the content 120 that is captured by either of the mobile wireless device 102 or the computing device 104 is shared between the connected devices utilizing the smart clipboard 118 of each respective connected device.

At 406, previously captured content is maintained utilizing the smart clipboard of each respective connected device, where the previously captured content is not overwritten by the captured content. For example, the clipboard content controller 122 maintains previously captured content utilizing the smart clipboard 118 of each respective connected device and does not overwrite the previously captured content with subsequent captured content.

At 408, the captured content is maintained until the captured content is utilized. For example, the clipboard content controller 122 maintains the captured content 120 utilizing the smart clipboard 118 at each respective connected device until the captured content is utilized or shared (also referred to as consumed). A user of a connected device may initiate to paste any combination of the several different captured content 120 into a message or into a social media communication shared with others, in which case the utilized, consumed, or shared captured content can be cleared from the smart clipboard 118 of each connected device.

At 410, the captured content is cleared from the smart clipboard of each respective connected device responsive to the captured content being utilized at one of the connected devices. For example, the clipboard content controller 122 for each connected device can clear the captured content 120 from the smart clipboard 118 of each respective connected device responsive to the captured content being utilized at one of the connected devices.

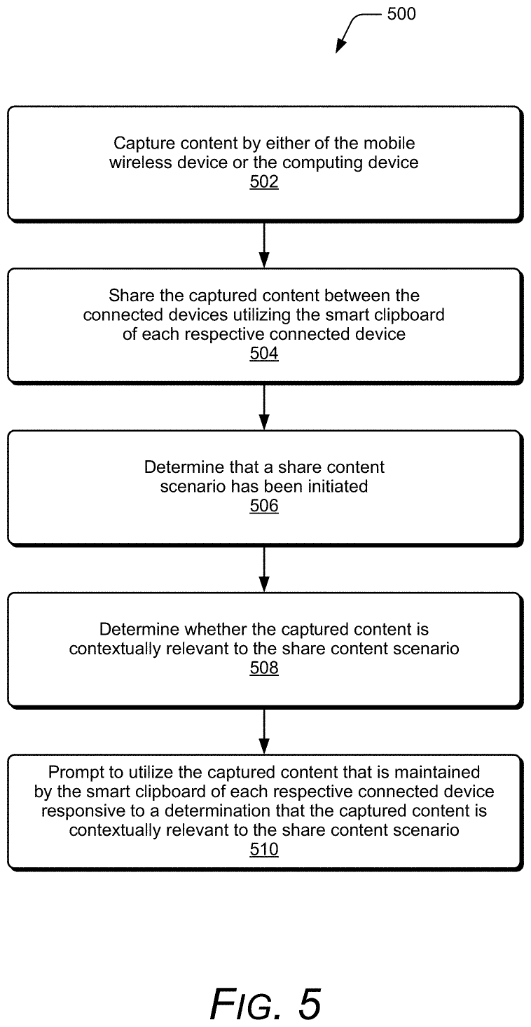

FIG. 5 illustrates example method(s) 500 for connected devices smart clipboard. The order in which the method is described is not intended to be construed as a limitation, and any number or combination of the described method operations can be performed in any order to perform a method, or an alternate method.

At 502, content is captured by either of the mobile wireless device or the computing device. For example, the mobile wireless device 102 and/or the computing device 104 captures content, which may be any type of a digital photo, copied text, a screenshot, an image, a video clip, a hyperlink, or any other type of copied content captured with an integrated camera device, a screen copy or screen grab function, or any other type of content copy functionality implemented by the mobile wireless device 102 and/or the computing device 104.

At 504, the captured content is shared between the connected devices utilizing the smart clipboard of each respective connected device. For example, the content 120 that is captured by either of the mobile wireless device 102 or the computing device 104 is shared between the connected devices utilizing the smart clipboard 118 of each respective connected device.

At 506, a determination is made that a share content scenario has been initiated. For example, the clipboard content controller 122 determines when a share content scenario has been initiated, such as by a user of the one of the connected devices. For example, a user of the mobile wireless device 102 may access a social media site or open a messaging application on the device. Given that the user may likely want to communicate recently captured content 120 via a social media post or in a text message, for example, the clipboard content controller 122 can determine or detect the likely share content scenario and prompt the user to utilize the captured content 120 that is maintained by the smart clipboard 118 of the connected device.

At 508, a determination is made as to whether the captured content is contextually relevant to the share content scenario. For example, the clipboard content controller 122 determines when a share content scenario has been initiated, and determines whether the captured content is contextually relevant to the share content scenario. In implementations, the clipboard content controller 122 can determine whether the captured content 120 is contextually relevant based on a time duration between the content being captured and the share content scenario being initiated. Alternatively or in addition, the clipboard content controller 122 may utilize natural language processing and/or optical character recognition to determine whether the captured content 120 is contextually relevant to the share content scenario.

At 510, a prompt is initiated to utilize the captured content that is maintained by the smart clipboard of each respective connected device responsive to a determination that the captured content is contextually relevant to the share content scenario. For example, the clipboard content controller 122 prompts to utilize the captured content 120 responsive to a determination that the captured content is contextually relevant to a share content scenario.

FIG. 6 illustrates various components of an example device 600, which can implement aspects of the techniques and features for connected devices smart clipboard, as described herein. The example device 600 can be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the mobile wireless device 102 and/or the computing device 104 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 can be used to couple the device to any type of components, peripherals, and/or accessory devices, such as a computer input device that may be integrated with the example device 600. The I/O interfaces 606 may also include data input ports via which any type of data, information, media content, communications, messages, and/or inputs can be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 can be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes a clipboard content controller 618 that implements various aspects of the described features and techniques described herein. The clipboard content controller 618 can be implemented with hardware components and/or in software as one of the device applications 614, such as when the example device 600 is implemented as the mobile wireless device 102 and/or the computing device 104 described with reference to FIGS. 1-5. An example of the clipboard content controller 618 is the clipboard content controller 122 implemented by each of the respective mobile wireless device 102 and the computing device 104, such as a software application and/or as hardware components in the wireless device and/or in the computing device. In implementations, the clipboard content controller 618 may include independent processing, memory, and logic components as a computing and/or electronic device integrated with the example device 600.

The example device 600 can also include a microphone 620 and/or camera devices 622, as well as motion sensors 624, such as may be implemented as components of an inertial measurement unit (IMU). The motion sensors 624 can be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for connected devices smart clipboard have been described in language specific to features and/or methods, the appended claims are not necessarily limited to the specific features or methods described. Rather, the specific features and methods are disclosed as example implementations for connected devices smart clipboard, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A method, comprising: sharing smart clipboard functionality between connected devices that include at least a mobile wireless device communicatively linked to a computing device, each of the connected devices implementing an instantiation of a smart clipboard; capturing content by either of the mobile wireless device or the computing device; sharing the captured content between the connected devices utilizing the smart clipboard of each respective connected device; and maintaining a content origin record associated with the captured content, the content origin record including at least an indication of which of the connected devices captured the content.

Alternatively or in addition to the above described method, any one or combination of: previously captured content is maintained utilizing the smart clipboard of each respective connected device and not overwritten by the captured content. The method further comprising maintaining the captured content until the captured content is utilized; and clearing the captured content from the smart clipboard of each respective connected device responsive to the captured content being utilized at one of the connected devices. The method further comprising determining that a share content scenario has been initiated; and prompting to utilize the captured content that is maintained by the smart clipboard of each respective connected device. The method further comprising determining that a share content scenario has been initiated; determining whether the captured content is contextually relevant to the share content scenario; and prompting to utilize the captured content responsive to a determination that the captured content is contextually relevant to the share content scenario. The determining that the captured content is contextually relevant is based at least in part on a time duration between the content being captured and the share content scenario being initiated. The method further comprising utilizing at least one of natural language processing or optical character recognition to determine that the captured content is contextually relevant to the share content scenario. The captured content includes at least one of a digital photo, copied text, a screenshot, an image, a video clip, a hyperlink, or copied content.

A mobile wireless device, comprising: a communication interface to wirelessly link connected devices that include the mobile wireless device linked to a computing device, each of the connected devices implementing an instantiation of a smart clipboard for content sharing between the connected devices; a clipboard content controller implemented at least partially in computer hardware to: share captured content between the connected devices utilizing the smart clipboard of each respective connected device; and maintain a content origin record associated with the captured content, the content origin record including at least an indication of which of the connected devices captured the content.

Alternatively or in addition to the above described mobile wireless device, any one or combination of: the clipboard content controller is configured to maintain previously captured content utilizing the smart clipboard of each respective connected device and not overwrite the previously captured content with the captured content. The clipboard content controller is configured to maintain the captured content until the captured content is utilized; and clear the captured content from the smart clipboard of each respective connected device responsive to the captured content being utilized at one of the connected devices. The clipboard content controller is configured to determine that a share content scenario has been initiated; and prompt to utilize the captured content that is maintained by the smart clipboard of each respective connected device. The clipboard content controller is configured to determine that a share content scenario has been initiated; determine that the captured content is contextually relevant to the share content scenario; and prompt to utilize the captured content responsive to the determination that the captured content is contextually relevant to the share content scenario. The clipboard content controller is configured to utilize at least one of natural language processing or optical character recognition to determine that the captured content is contextually relevant to the share content scenario. The mobile wireless device further comprising a capture module to capture the captured content as at least one of a digital photo, copied text, a screenshot, an image, a video clip, a hyperlink, or copied content.

A system, comprising: connected devices that include at least a mobile wireless device communicatively linked to a computing device, each of the connected devices implementing an instantiation of a smart clipboard; a clipboard content controller implemented at least partially in computer hardware to: share captured content between the connected devices utilizing the smart clipboard of each respective connected device; and maintain a content origin record associated with the captured content, the content origin record including at least an indication of which of the connected devices captured the content.

Alternatively or in addition to the above described system, any one or combination of: the clipboard content controller is configured to clear the captured content from the smart clipboard of each respective connected device responsive to the captured content being utilized at one of the connected devices. The clipboard content controller is configured to prompt to utilize the captured content that is maintained by the smart clipboard of each respective connected device responsive to a share content scenario being detected. The clipboard content controller is configured to determine that the captured content is contextually relevant to a share content scenario. The clipboard content controller is configured to prompt to utilize the captured content that is maintained by the smart clipboard of each respective connected device responsive to a determination that the captured content is contextually relevant to a share content scenario.

1. A method, comprising:
sharing smart clipboard functionality between connected devices that include at least a mobile wireless device communicatively linked to a computing device, each of the connected devices implementing an instantiation of a smart clipboard;
capturing content by either of the mobile wireless device or the computing device;
sharing the captured content between the connected devices utilizing the smart clipboard of each respective connected device; and
maintaining a content origin record associated with the captured content, the content origin record including at least an indication of which of the connected devices captured the content.

2. The method as recited in claim 1, wherein previously captured content is maintained utilizing the smart clipboard of each respective connected device and not overwritten by the captured content.

3. The method as recited in claim 1, further comprising:
maintaining the captured content until the captured content is utilized; and
clearing the captured content from the smart clipboard of each respective connected device responsive to the captured content being utilized at one of the connected devices.

4. The method as recited in claim 1, further comprising:
determining that a share content scenario has been initiated; and
prompting to utilize the captured content that is maintained by the smart clipboard of each respective connected device.

5. The method as recited in claim 1, further comprising:
determining that a share content scenario has been initiated;
determining whether the captured content is contextually relevant to the share content scenario; and
prompting to utilize the captured content responsive to a determination that the captured content is contextually relevant to the share content scenario.

6. The method as recited in claim 5, wherein the determining that the captured content is contextually relevant is based at least in part on a time duration between the content being captured and the share content scenario being initiated.

7. The method as recited in claim 1, further comprising:
utilizing at least one of natural language processing or optical character recognition to determine that the captured content is contextually relevant to the share content scenario.

8. The method as recited in claim 1, wherein the captured content includes at least one of a digital photo, copied text, a screenshot, an image, a video clip, a hyperlink, or copied content.

9. A mobile wireless device, comprising:
a communication interface to wirelessly link connected devices that include the mobile wireless device linked to a computing device, each of the connected devices implementing an instantiation of a smart clipboard for content sharing between the connected devices;
a clipboard content controller implemented at least partially in computer hardware to:
share captured content between the connected devices utilizing the smart clipboard of each respective connected device; and
maintain a content origin record associated with the captured content, the content origin record including at least an indication of which of the connected devices captured the content.

10. The mobile wireless device as recited in claim 9, wherein the clipboard content controller is configured to maintain previously captured content utilizing the smart clipboard of each respective connected device and not overwrite the previously captured content with the captured content.

11. The mobile wireless device as recited in claim 9, wherein the clipboard content controller is configured to:
maintain the captured content until the captured content is utilized; and
clear the captured content from the smart clipboard of each respective connected device responsive to the captured content being utilized at one of the connected devices.

12. The mobile wireless device as recited in claim 9, wherein the clipboard content controller is configured to:
determine that a share content scenario has been initiated; and
prompt to utilize the captured content that is maintained by the smart clipboard of each respective connected device.

13. The mobile wireless device as recited in claim 9, wherein the clipboard content controller is configured to:
determine that a share content scenario has been initiated;
determine that the captured content is contextually relevant to the share content scenario; and
prompt to utilize the captured content responsive to the determination that the captured content is contextually relevant to the share content scenario.

14. The mobile wireless device as recited in claim 13, wherein the clipboard content controller is configured to utilize at least one of natural language processing or optical character recognition to determine that the captured content is contextually relevant to the share content scenario.

15. The mobile wireless device as recited in claim 9, further comprising a capture module to capture the captured content as at least one of a digital photo, copied text, a screenshot, an image, a video clip, a hyperlink, or copied content.

16. A system, comprising:
connected devices that include at least a mobile wireless device communicatively linked to a computing device, each of the connected devices implementing an instantiation of a smart clipboard;
a clipboard content controller implemented at least partially in computer hardware to:
share captured content between the connected devices utilizing the smart clipboard of each respective connected device; and
maintain a content origin record associated with the captured content, the content origin record including at least an indication of which of the connected devices captured the content.

17. The system as recited in claim 16, wherein the clipboard content controller is configured to clear the captured content from the smart clipboard of each respective connected device responsive to the captured content being utilized at one of the connected devices.

18. The system as recited in claim 16, wherein the clipboard content controller is configured to prompt to utilize the captured content that is maintained by the smart clipboard of each respective connected device responsive to a share content scenario being detected.

19. The system as recited in claim 16, wherein the clipboard content controller is configured to determine that the captured content is contextually relevant to a share content scenario.

20. The system as recited in claim 16, wherein the clipboard content controller is configured to prompt to utilize the captured content that is maintained by the smart clipboard of each respective connected device responsive to a determination that the captured content is contextually relevant to a share content scenario.
